(19) United States
(12) Patent Application Publication
(10) Pub. No.: US 2021/0304172 A1
(43) Pub. Date: Sep. 30, 2021

(54) COMMODITY SALES PROCESSING SYSTEM, AND COMMODITY SALES PROCESSING METHOD

(71) Applicant: TOSHIBA TEC KABUSHIKI KAISHA, Tokyo (JP)

(72) Inventor: Tomoka IWAMA, Mishima Shizuoka (JP)

(73) Assignee: TOSHIBA TEC KABUSHIKI KAISHA, Tokyo (JP)

(21) Appl. No.: 17/179,063

(22) Filed: Feb. 18, 2021

(30) Foreign Application Priority Data
Mar. 24, 2020 (JP) 2020-053065

(51) Int. Cl. G06Q 20/20; G06Q 20/32

(52) U.S. Cl. CPC G06Q 20/204; G06Q 20/322; G06Q 20/327; G06Q 20/208; G06Q 20/209

(57) ABSTRACT

A commodity sales processing system includes a communication interface and a processor. The communication interface is configured to communicate with a communication terminal. The communication terminal is configured to acquire commodity data regarding commodities to be purchased by a consumer during a shopping event. The processor is configured to set a settlement method for the shopping event that is used in settlement with the consumer for purchasing the commodities, receive the commodity data from the communication terminal, and execute a settlement process based on the commodity data and the settlement method. In response to a first settlement method being set, the processor is configured to execute the settlement process when the shopping event is completed. In response to a second settlement method being set, the processor is configured to execute the settlement process each time the commodity data is received from the communication terminal such that each commodity is individually settled.

### CROSS-REFERENCE TO RELATED APPLICATION

This application is based upon and claims the benefit of priority from Japanese Patent Application No. 2020-053065, filed on Mar. 24, 2020, the entire contents of which are incorporated herein by reference.

### FIELD

Embodiments described herein relate generally to a commodity sales processing system and a commodity sales processing method.

### BACKGROUND

In recent years, a commodity sales processing system has been proposed in which consumers register purchased commodities by themselves while shopping for actual stores such as supermarkets and convenience stores. One example is a system that uses a cart terminal. The cart terminal is equipped with a scanner and a display device and is attached to a shopping cart. In such type of system, the consumer causes the scanner of the cart terminal to read the barcode attached to the purchased commodity. Then, the barcode data is transmitted from the cart terminal to the store server via the wireless local area network (LAN). The server registers the sales data of the purchased commodity based on the barcode data and transmits the registration screen data indicating the processing result to the cart terminal. The cart terminal causes the display device to display the registration screen based on the registration screen data.

In such a commodity sales processing system, since the consumer scans the barcode of the commodity at the timing of putting the purchased commodity in the shopping cart, the time and efforts for checking out can be greatly reduced.

On the other hand, a settlement process for payment needs to be executed with a checkout machine. Therefore, even if the number of purchased commodities is small, it is necessary to perform the operation for settlement in the same manner as the consumer who has many purchased commodities. There is a possibility that waiting time for checkout will occur during congestion. If electronic money is desired to be used during the settlement process and the settlement cannot be completed due to the insufficient balance, or the like, there can be situations where it takes time and efforts for the operation, such as stopping the purchase of the commodity, deleting the registered commodities, or executing the settlement process again using another payment method.

### DESCRIPTION OF THE DRAWINGS

FIG. 1 is a block diagram showing a configuration of a commodity sales processing system of the present embodiment;

FIG. 2 is a block diagram showing a main circuit configuration of a first communication terminal;

FIG. 3 is a perspective view showing an example of a shopping cart provided with the first communication terminal;

FIG. 4 is a block diagram showing a main circuit configuration of a second communication terminal;

FIG. 5 is a block diagram showing a main circuit configuration of a virtual point-of-sale (POS) server;

FIG. 6 is a schematic diagram showing a data structure of a transaction information file managed by the virtual POS server;

FIG. 7 is a flowchart for illustrating the operation of the virtual POS server in the present embodiment;

FIG. 8 is a diagram showing an outline of a processing flow when a second settlement method is executed; and

FIGS. 9A and 9B are diagrams for illustrating an output result when the second settlement method is executed.

### DETAILED DESCRIPTION

The problem to be solved by the embodiment of the present disclosure is to provide a commodity sales processing system and a commodity sales processing method capable of improving the operability.

In general, according to one embodiment, the commodity sales processing system includes a communication unit, a settlement method setting unit, and a settlement processing unit. The communication unit communicates with a communication terminal that inputs data of a commodity to be purchased by the operation when the consumer is shopping. The settlement method setting unit sets a settlement method to be used in settlement by the consumer for purchasing a commodity. The settlement processing unit executes the settlement process by the settlement method based on the commodity data each time the commodity data is received from the communication terminal by the communication unit.

Hereinafter, the present embodiment will be described with reference to the drawings.

The present embodiment exemplifies a commodity sales processing system that enables a consumer to register a commodity to be purchased by operating a communication terminal when shopping in a store. In the commodity sales processing system, as the communication terminal, a first communication terminal (sometimes called a cart point of sales (POS)) that can be used by attaching to a shopping cart, and a second communication terminal (sometimes called a smartphone POS) such as a smartphone owned by a consumer who is a shopper can be used in combination.

In the commodity sales processing system of the present embodiment, it is possible to implement a first settlement method in which the data of the commodity to be purchased that was registered by the operation of the consumer on the first communication terminal (cart POS) or the second communication terminal (smartphone POS) is subjected to the execution of the settlement process in response to a closing operation, and a second settlement method in which a settlement method by the electronic settlement is set in advance and the settlement process is executed each time the commodity data is input. When the second settlement method is used, it is possible to output the output data (for example, receipt data) summarizing the data of a plurality of commodities that were individually settled.

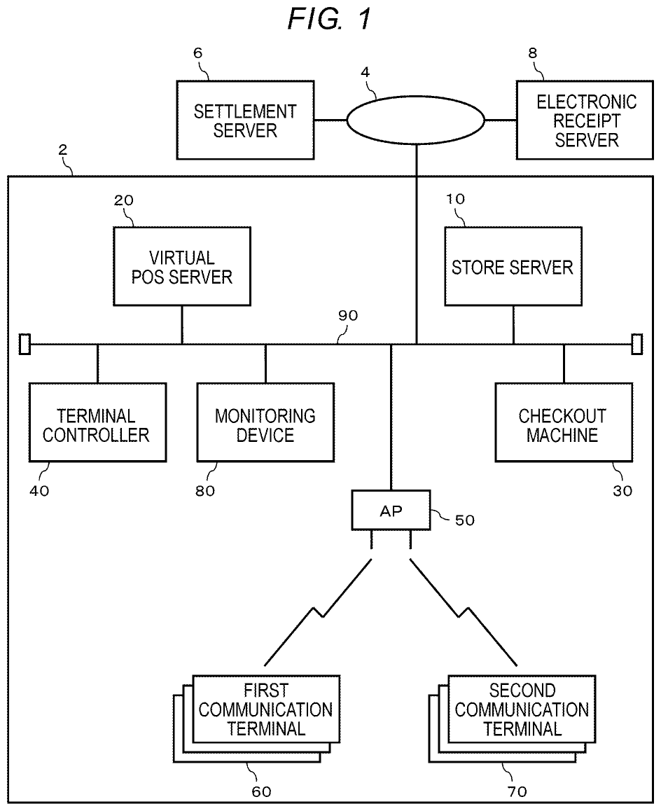

FIG. 1 is a block diagram showing a configuration of a commodity sales processing system 2 of the present embodiment.

The commodity sales processing system 2 is connected to a settlement server 6 and an electronic receipt server 8 via a network 4 such as the Internet.

The settlement server 6 is a server that performs the settlement process by electronic settlement for commodities registered by a consumer through a communication terminal in the commodity sales processing system 2. For electronic settlement by the settlement server 6, for example, a credit card or electronic money can be used.

The electronic receipt server 8 acquires and accumulates receipt data representing the details of transactions that were settled by the commodity sales processing system 2 and the checkout results from the commodity sales processing system 2. The electronic receipt server 8 generates receipt screen data representing a receipt image representing the details of the receipt data and transmits the receipt screen data to an electronic device (for example, a smartphone or the like used as the second communication terminal 70) owned by the user. The electronic receipt server 8 manages membership codes for identifying users for managing receipt data and has a function as a user management device for managing the membership code.

The commodity sales processing system 2 in the present embodiment includes a store server 10, a virtual POS server 20, a checkout machine 30, a terminal controller 40, an access point 50, a monitoring device 80, and a communication network 90. As the communication network 90, for example, a wired local area network (LAN), a wireless LAN, or the like is used. The store server 10, the virtual POS server 20, the checkout machine 30, the terminal controller 40, the access point 50, and the monitoring device 80 are connected to the communication network 90, respectively.

The access point 50 is a device that constitutes a wireless LAN together with the first communication terminal 60 and the second communication terminal 70. The access point 50 serves as a data relay base for exchanging data between the first communication terminal 60, the second communication terminal 70, and/or the monitoring device 80 connected by the wireless LAN, and each device connected by the wired LAN. The number of access points 50 is not limited to one. Two or more access points 50 may be connected to the communication network 90 considering the size and layout of the store. The access point 50 can be limited to communicate with the first communication terminal 60 in a limited range in the store, for example, a shopping cart storage area. That is, when it becomes possible to communicate with the first communication terminal 60 through the access point 50 provided in the shopping cart storage area, it is possible to determine that the shopping cart with the first communication terminal 60 attached thereto was returned to the storage area.

The first communication terminal 60 and the second communication terminal 70 are used for inputting data of commodities to be purchased by the operation of the consumer when the consumer is shopping in the store. Specifically, the first communication terminal 60 and the second communication terminal 70 are used to read a barcode indicating a commodity code attached to a commodity.

The first communication terminal 60 may be attached to a shopping cart and used. The first communication terminal 60 may be rented from the store to a consumer and carried by the consumer. Therefore, the first communication terminal 60 is typically operated by a consumer.

Similar to the first communication terminal 60, the second communication terminal 70 is a portable electronic device for supporting the shopping behavior of consumers in the store where the commodity sales processing system 2 is configured. The second communication terminal 70 is, for example, a communication terminal such as a smartphone or tablet terminal individually owned by a consumer. Therefore, the consumer is the operator of the second communication terminal 70.

The monitoring device 80 is an electronic device for monitoring the state of the first communication terminal 60 and the second communication terminal 70. The monitoring device 80 notifies the virtual POS server 20 when the states of the first communication terminal 60 and the second communication terminal 70 can be determined to be the end of shopping by the consumer (end of the use for inputting data). For example, the monitoring device 80 can determine the end of the use of the first communication terminal 60 (cart POS) when the communication with the first communication terminal 60 (cart POS) is through the access point 50 whose communication range is limited to the shopping cart storage area. That is, the end of the use is determined by detecting that the shopping cart equipped with the first communication terminal 60 was returned to the shopping cart storage area. The monitoring device 80 can determine the end of the use of the second communication terminal 70 (smartphone POS) when a predetermined time has passed since the communication with the second communication terminal 70 via the access point 50 was cut off. That is, the end of the use is determined when the consumer who owns the second communication terminal 70 moves to a position where communication is not possible between the second communication terminal 70 and the access point 50 (for example, outside the sales floor, outside the store, or the like) and does not return within a certain period of time. Alternatively, the end of the use is determined when it is determined that the position detected by a position detection function of the second communication terminal 70 moved to a specific range such as outside the sales floor or outside the store.

It is also possible to use a method other than the above for determining the end of the use of the first communication terminal 60 or the second communication terminal 70.

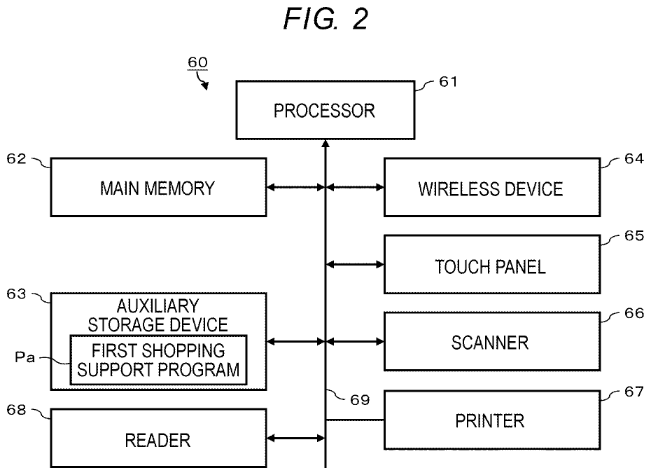

FIG. 2 is a block diagram showing a main circuit configuration of the first communication terminal 60. The first communication terminal 60 includes a processor 61, a main memory 62, an auxiliary storage device 63, a wireless device 64 (a communications interface, a transceiver), a touch panel 65, a scanner 66, a printer 67, a reader 68, and a system transmission line 69. The system transmission line 69 includes an address bus, a data bus, a control signal line, and the like. The first communication terminal 60 connects the processor 61, the main memory 62, the auxiliary storage device 63, the wireless device 64, the touch panel 65, and the scanner 66 to the system transmission line 69. In the first communication terminal 60, a computer is configured of the processor 61, the main memory 62, the auxiliary storage device 63, and the system transmission line 69 connecting the above.

The processor 61 corresponds to the central part of the computer. The processor 61 controls each unit in order to realize various functions as the first communication terminal 60 according to the operating system or the application program. The processor 61 is, for example, a central processing unit (CPU).

The main memory 62 corresponds to the main memory part of the computer. The main memory 62 includes a non-volatile memory area and a volatile memory area. The main memory 62 stores an operating system or an application program in the non-volatile memory area. The main memory 62 stores data necessary for the processor 61 to execute a process for controlling each part in the volatile memory area. The above data may be stored in the non-volatile memory area. The main memory 62 uses the volatile memory area as a work area where data is appropriately rewritten by the processor 61. The non-volatile memory area is, for example, a read only memory (ROM). The volatile memory area is, for example, a random access memory (RAM).

The auxiliary storage device 63 corresponds to the auxiliary storage part of the computer. For example, an electric erasable programmable read-only memory (EEPROM), a hard disc drive (HDD), a solid state drive (SSD), or the like can be the auxiliary storage device 63. The auxiliary storage device 63 stores data used by the processor 61 to execute various processes, data created by the processes of the processor 61, and the like. The auxiliary storage device 63 may store the above application program.

The wireless device 64 is a device for wirelessly communicating data with the access point 50 via a wireless LAN.

The touch panel 65 is a device that serves as both an input device and a display device of the first communication terminal 60. The touch panel 65 displays various images. Then, the touch panel 65 detects the touch position with respect to the displayed image and outputs the touch position information to the processor 61.

The scanner 66 is a device used for reading data codes such as barcodes and two-dimensional codes. The scanner 66 may be a device that scans with a laser beam and optically reads a data code, or may be a device that processes an image including a data code taken by a camera and reads the data code.

The printer 67 dispenses a paper receipt by printing various character strings or images on the receipt paper.

The reader 68 reads the data recorded on a recording medium and outputs the read data to the processor 61. The reader 68 is a magnetic card reader when the recording medium is a magnetic card, and is an integrated circuit (IC) card reader when the recording medium is a contact type IC card. In the case of a recording medium using non-contact communication such as a non-contact type IC card or a smartphone, a non-contact type reader is used as the reader 68.

The reader 68 of the present embodiment can be held in a state where a recording medium such as a contact type IC card, a non-contact type IC card, or a smartphone is mounted thereon. The reader 68 can read data from the mounted recording medium at any timing instructed by the processor 61.

The recording medium may include a membership card (store member) issued to a member (consumer) registered as a member of the store, or a membership card issued to a member (electronic receipt member) registered in the electronic receipt service provided by the electronic receipt server 8. A unique membership code (the store membership code, and the electronic receipt membership code) is recorded on the membership card as customer identification information. The reader 68 can read the membership code recorded on the membership card.

The first communication terminal 60 has a first shopping support program Pa installed in the auxiliary storage device 63 as an application program. The method of installing the first shopping support program Pa on the auxiliary storage device 63 is not particularly limited. The first shopping support program Pa can be installed in the auxiliary storage device 63 by recording the first shopping support program Pa on a removable recording medium or distributing the first shopping support program Pa by communication via a network. The recording medium may be in any form, such as a CD-ROM or a memory card, as long as the device can store a program and is readable. The installation destination of the first shopping support program Pa may be the main memory 62.

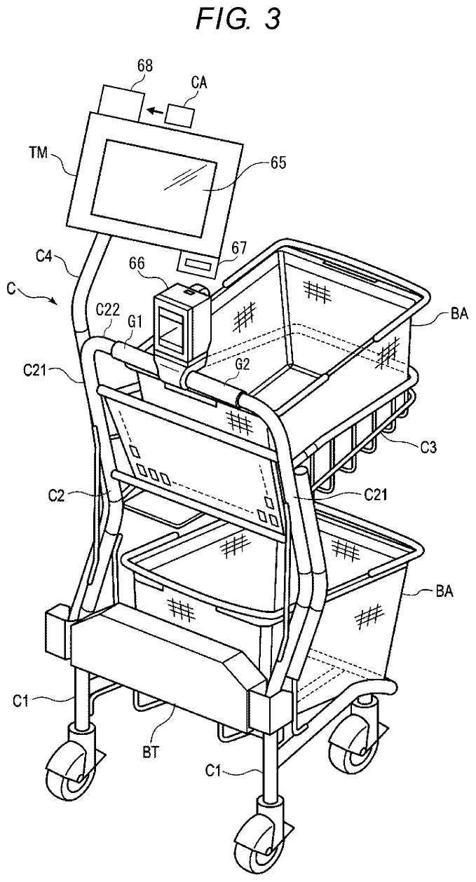

FIG. 3 is a perspective view showing an example of a shopping cart C provided with the first communication terminal 60. The shopping cart C includes a caster portion C1 for movement, a handle frame portion C2, and a basket receiving portion C3. The caster portion C1 includes four wheels for smoothly moving on the floor surface. The handle frame portion C2 includes a pair of vertical frames C21 erected on the rear wheel side of the caster portion C1 and a handlebar C22 connecting the upper ends of the vertical frames C21. The basket receiving portion C3 is located in front of the middle portion of the handle frame portion C2. The shopping cart C can be placed with a shopping basket BA for accommodating commodities on the basket receiving portion C3 and the caster portion C1.

The scanner 66 is in the middle of the handlebar C22. The scanner 66 is attached to the handlebar C22 so that the reading window is located on the front side. The front side is the side on which the customer who pushes the shopping cart C in holding the handlebar C22 stands.

A pole C4 is attached to one of the vertical frames C21. The tip of the pole C4 is located above the handlebar C22. A tablet terminal TM is attached to the tip of the pole C4 with the screen of the touch panel 65 facing forward. The reader 68 is attached to, for example, the tablet terminal TM. In FIG. 3, the reader 68 is capable of reading data while holding the recording medium CA by moving a recording medium CA such as a contact type IC card in the direction of the arrow in the drawing. A battery BT is attached to the lower end side of the handle frame portion C2 over the vertical frames C21. The battery BT serves as a driving power source for the tablet terminal TM and the scanner 66.

Grips G1 and G2 are mounted on the handlebar C22 to cover the outer circumferences of the left and right portions of the handlebar C22 with the scanner 66 interposed therebetween. The grips G1 and G2 are for the customer to hold in order to move the shopping cart C.

Although FIG. 3 shows an example in which the tablet terminal TM (touch panel 65) and the scanner 66 are separated from each other, an integrated configuration is also possible.

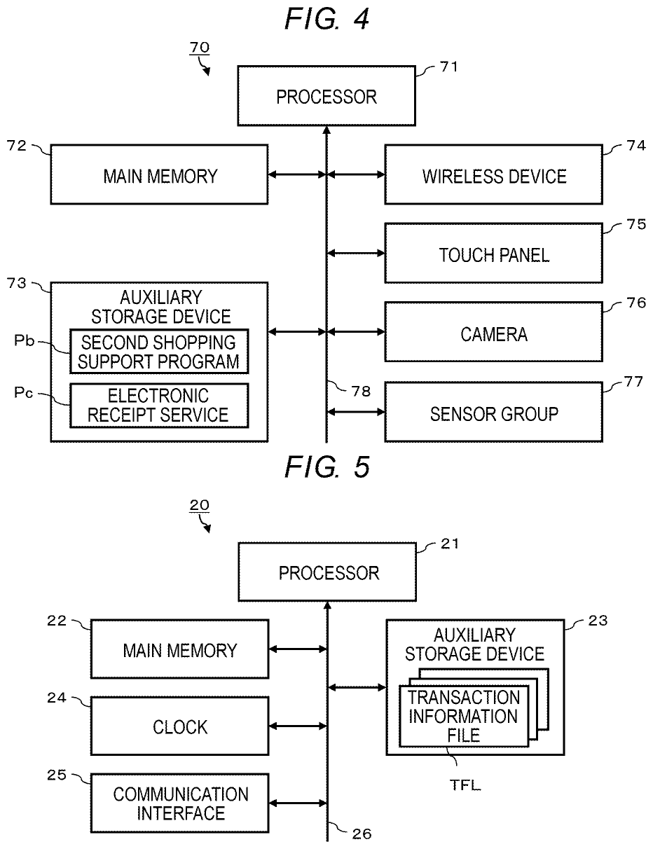

FIG. 4 is a block diagram showing a main circuit configuration of the second communication terminal 70. The second communication terminal 70 includes a processor 71, a main memory 72, an auxiliary storage device 73, a wireless device 74 (a communications interface, a transceiver), a touch panel 75, a camera 76, a sensor group 77, and a system transmission line 78. The system transmission line 78 includes an address bus, a data bus, a control signal line, and the like. The second communication terminal 70 connects the processor 71, the main memory 72, the auxiliary storage device 73, the wireless device 74, the touch panel 75, the camera 76, and the sensor group 77 to the system transmission line 78. In the second communication terminal 70, a computer is configured of the processor 71, the main memory 72, the auxiliary storage device 73, and the system transmission line 78 connecting the above.

The descriptions of the processor 71, the main memory 72, the auxiliary storage device 73, the wireless device 74, and the touch panel 75 overlap with the descriptions of the processor 61, the main memory 62, the auxiliary storage device 63, the wireless device 64, and the touch panel 65 for the first communication terminal 60. Therefore, the descriptions thereof are omitted here.

The camera 76 is an imaging device built in the second communication terminal 70. The camera 76 operates as an imaging device of a still image or a moving image, or as a scanning device of a data code such as a barcode or a two-dimensional code, by an application program installed in the second communication terminal 70.

The sensor group 77 includes, for example, a global positioning system (GPS) sensor, a magnetic sensor, an acceleration sensor, a gyro sensor, an ambient light sensor, and the like. The data detected by the sensor group 77 is used, for example, by a position detection function that detects the position, moving distance, and moving direction of the second communication terminal 70. Data indicating the position of the second communication terminal 70 or the like detected by the position detection function is transmitted to, for example, the monitoring device 80.

The second communication terminal 70 has a second shopping support program Pb and an electronic receipt service program Pc installed in the auxiliary storage device 73 as application programs. The method of installing the second shopping support program Pb on the auxiliary storage device 73 is also not particularly limited. The same method as the first shopping support program Pa can be applied as it is. The installation destination of the second shopping support program Pb and the electronic receipt service program Pc may be the main memory 72.

The checkout machine 30 is a terminal for making a settlement for a commodity registered as a purchase target by the operation of the consumer. The checkout machine 30 is used when the settlement process is not executed in the first communication terminal 60 or the second communication terminal 70. The checkout machine 30 acquires checkout data for commercial transactions from the virtual POS server 20 and settles commercial transactions based on the checkout data. The checkout machine 30 can settle commercial transactions by a well-known settlement method such as cash settlement, credit card settlement, electronic money settlement, point settlement, and/or code settlement (also referred to as mobile settlement or smartphone settlement).

The store server 10 supports overall store operations. For the support, the store server 10 manages various databases such as a commodity database, a member database, and the like.

The commodity database is a collection of commodity records in which data on each commodity sold in the store is stored. A commodity record is composed of data items such as a commodity code, a commodity name, a price, and discount information. The commodity code is a unique identification code set for each commodity in order to individually identify each commodity. Each commodity has a barcode indicating the commodity code. The discount information is information related to commodity discounts such as the discount amount and discount rate.

The member database is a collection of member records in which data related to consumers (members) who registered as members is stored. The membership record includes data items such as a membership code and accumulated points. The membership code is a unique identification code set for each member to identify each member. Accumulated points are the accumulated points given to consumers who are members in commercial transactions with members.

The virtual POS server 20 cooperates with the first communication terminal 60 and/or the second communication terminal 70 to execute a process for providing the same function as a well-known POS terminal. The virtual POS server 20 executes a registration process of a purchased commodity based on the data input from the touch panel 65 and/or the scanner 66 of the first communication terminal 60 and/or the data input from the touch panel 75 and/or the camera 76 of the second communication terminal 70, and executes electronic settlement (using a credit card, electronic money, or the like) by the settlement method specified by the consumer for the registered commodity.

The first communication terminal 60 or the second communication terminal 70 is provided with the function of the virtual POS server 20, and the processing to be executed by the first communication terminal 60 or the second communication terminal 70, and the virtual POS server 20, which will be described later, in cooperation with each other is enabled to be executed by one device.

FIG. 5 is a block diagram showing a main circuit configuration of the virtual POS server 20. The virtual POS server 20 includes a processor 21, a main memory 22, an auxiliary storage device 23, a clock 24, a communication interface 25, and a system transmission line 26. The system transmission line 26 includes an address bus, a data bus, a control signal line, and the like. The virtual POS server 20 connects the processor 21, the main memory 22, the auxiliary storage device 23, the clock 24, and the communication interface 25 to the system transmission line 26. In the virtual POS server 20, a computer is configured of the processor 21, the main memory 22, the auxiliary storage device 23, and the system transmission line 26 connecting the above.

Since the descriptions of the processor 21, the main memory 22, and the auxiliary storage device 23 overlap with the descriptions of the processor 61, the main memory 62, and the auxiliary storage device 63 for the first communication terminal 60, the descriptions thereof are omitted here.

The clock 24 functions as a time information source for the virtual POS server 20. The processor 21 tracks the current date and time based on the time information tracked by the clock 24.

The communication interface 25 is a circuit for performing data communication with each unit connected via the communication network 90. The communication interface 25 can perform data communication with the first communication terminal 60 and/or the second communication terminal 70 in which the access point 50 and the communication line are established.

The virtual POS server 20 forms, in the auxiliary storage device 23, a storage area for storing a plurality of transaction information files TFL, which correspond to the respective purchases performed using the first communication terminal 60 and the second communication terminal 70. The data structure of the transaction information file TFL will be described later.

The terminal controller 40 controls the operations of the first communication terminal 60, the second communication terminal 70, and the monitoring device 80, which are connected by wireless LAN via the access point 50. The terminal controller 40 causes the first communication terminal 60 to function as an input and output interface of the POS terminal by exchanging data commands with the first communication terminal 60 on which the first shopping support program Pa is executed. The terminal controller 40 causes the second communication terminal 70 to function as an input and output interface of the POS terminal by exchanging data commands with the second communication terminal 70 on which the second shopping support program Pb is executed.

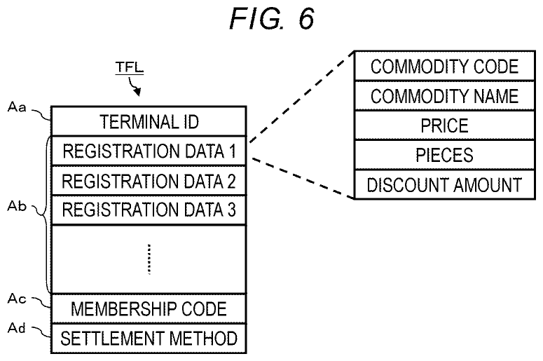

FIG. 6 is a schematic diagram showing the data structure of the transaction information file TFL managed by the auxiliary storage device 23 of the virtual POS server 20. As shown in FIG. 6, the transaction information file TFL is configured with an area Aa for storing a terminal ID, an area Ab for storing a plurality of registration data, an area Ac for storing a membership code, and an area Ad for storing data indicating the settlement method. The terminal ID is a unique identification code set in the main memory 62 or the auxiliary storage device 63 by the first shopping support program Pa in the first communication terminal 60. The terminal ID is a unique identification code set in the main memory 72 or the auxiliary storage device 73 by the second shopping support program Pb in the second communication terminal 70.

The registration data is data related to commodities registered as purchase targets on the first communication terminal 60 and/or the second communication terminal 70. The registration data is composed of each item data of the commodity code, the commodity name, the price, points, and the discount amount. The registration data registered in one transaction information file TFL is collectively output as output data (for example, receipt data) when the second settlement method for executing the settlement process is executed each time commodity data is input. When outputting as receipt data, either one or both of a paper receipt printed on the receipt paper and an electronic receipt provided as electronic data by the electronic receipt server 8 are used as the receipt format.

The membership code is data that identifies the consumer entered in the first communication terminal 60 and/or the second communication terminal 70. The membership code includes, for example, a membership code issued to a member of the store or a membership code registered in the electronic receipt service provided by the electronic receipt server 8.

The settlement method is data indicating the electronic settlement method specified (e.g., when the second settlement method is used) for the purchase using the first communication terminal 60 and/or the second communication terminal 70.

Next, the operation of the commodity sales processing system in this embodiment will be described.

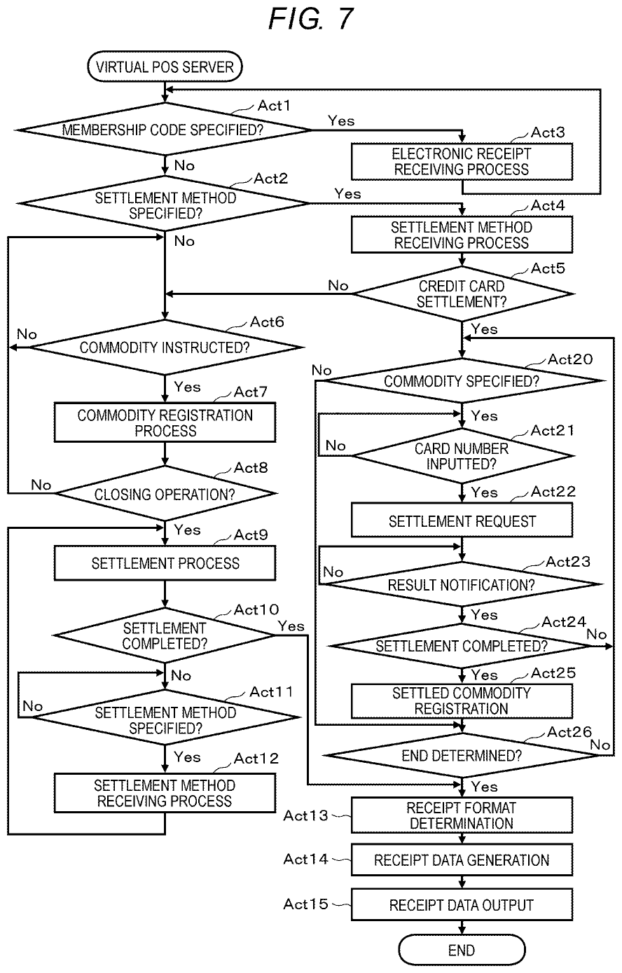

FIG. 7 is a flowchart for illustrating the operation of the virtual POS server 20 in the embodiment.

In the commodity sales processing system of the embodiment, it is necessary for the consumer to be registered as a member of the store in advance in order to shop using the first communication terminal 60 and/or the second communication terminal 70. By registering as a member, a unique store membership code is issued. The store membership code is recorded on the store membership card and issued to the consumer. The store membership code may be downloaded and issued to a smartphone or the like owned by the consumer.

Before starting shopping, the consumer who visits the store decides whether to use the first communication terminal 60 attached to the shopping cart in the store or the second communication terminal 70 such as a smartphone owned by the consumer.

For example, when the power of the first communication terminal 60 is turned on by a clerk before the opening of the store, the first shopping support program Pa is activated. When the first shopping support program Pa is activated, the processor 61 establishes a communication line with the access point 50 according to a predetermined communication protocol. Then, when the communication line is established, the processor 61 transmits the terminal ID to the terminal controller 40 and then goes into an idle state. The terminal controller 40 stores the terminal ID received from the first communication terminal 60.

The consumer who uses the first communication terminal 60 selects a shopping cart to which the first communication terminal 60 in an idle state is attached. The consumer causes the scanner 66 to read the store membership code recorded on the membership card. The consumer may cause the scanner 66 to read the store membership code downloaded to the smartphone. The processor 61 of the first communication terminal 60 receives the consumer's declaration of the start of use by reading the store membership code with the scanner 66.

The consumer who uses the second communication terminal 70 activates the second shopping support program Pb. When the second shopping support program Pb is activated, the processor 71 enters the data code reading mode. For example, the consumer causes the camera 76 to read a data code for entering the store provided at the entrance of the store. In the data code, parameters, and the like required for communication at the store are coded and recorded. The processor 71 receives the consumer's declaration of the start of use by reading the data code with the camera 76.

Hereinafter, it will be described assuming that the consumer makes a purchase using the first communication terminal 60.

When the consumer desires to acquire the shopping details by the electronic receipt by using the electronic receipt service provided by the electronic receipt server 8, the consumer causes the scanner 66 to read the electronic receipt membership code before the settlement process.

When the electronic receipt membership code is read by the scanner 66, the processor 61 transmits the read electronic receipt membership code to the virtual POS server 20 together with the terminal ID. When the electronic receipt membership code is received from the first communication terminal 60 (ACT 1, Yes), the processor 21 of the virtual POS server 20 performs the electronic receipt receiving process (ACT 3). The processor 21 sets the electronic receipt membership code in the area Ac of the transaction information file TFL in which the received terminal ID is set, and sets the receipt format to be the electronic receipt.

The reading of the electronic receipt membership code (use of the electronic receipt service) may be possible to be carried out at any time as long as the reading is before the settlement process is completed in the case of the first settlement method, and before the shopping is completed (before it is determined that the settlement is completed) in the case of the second settlement method.

In the commodity sales processing system 2 of the present embodiment, when the second settlement method is used, the settlement method by the electronic settlement is specified in advance before the consumer registers the commodity (reads the barcode). On the other hand, when using the first settlement method, a settlement method other than an electronic settlement is specified before registering the commodity, or a settlement method is specified after the closing operation after the registration of the commodity to be purchased is completed.

For example, in the first communication terminal 60, it is assumed that the settlement method is specified by, for example, operating a button provided on the touch panel 65 by the consumer. The processor 61 of the first communication terminal 60 notifies the virtual POS server 20 of the specified settlement method together with the terminal ID.

When the processor 21 of the virtual POS server 20 is notified of the specification of the settlement method from the first communication terminal 60 (ACT 2, Yes), the processor 21 executes the settlement method receiving process (ACT 4). That is, the processor 21 stores data indicating the specified settlement method in the area Ad of the transaction information file TFL in which the terminal ID received from the first communication terminal 60 is set.

Here, for example, it is assumed that a cash settlement method is specified and the electronic settlement including credit card settlement is not specified (ACT 5, No). Therefore, when the electronic settlement is not specified, or when the commodity registration (reading of the barcode of the commodity) is executed without a settlement method being specified, the first settlement method is executed.

The case where the first settlement method is executed will be described below.

The consumer causes the scanner 66 to read the barcode indicating the commodity code attached to the commodity to be purchased. When the commodity code is acquired, the processor 61 transmits the acquired commodity code to the virtual POS server 20 together with the terminal ID. Upon receiving the commodity code received from the first communication terminal 60 (ACT 6, Yes), the processor 21 of the virtual POS server 20 inquires about the data related to the commodity corresponding to the commodity code.

In response to the inquiry from the virtual POS server 20, the store server 10 reads the data corresponding to the commodity code from the commodity database and transmits the read data to the virtual POS server 20.

The processor 21 of the virtual POS server 20 stores the data related to the commodity received from the store server 10 in the area Ab of the transaction information file TFL in which the terminal ID received from the first communication terminal 60 is set. That is, the processor 21 registers the commodity to be purchased (ACT 7).

When purchasing a plurality of commodities, the consumer can register the commodities by reading the barcode of the commodities with the scanner 66 in the same manner as described above (ACT 6 and ACT 7).

When the commodity registration for all the commodities to be purchased is completed, the consumer performs a closing operation by, for example, operating a button provided on the touch panel 65. Upon detecting the closing operation, the processor 61 of the first communication terminal 60 notifies the virtual POS server 20 that the closing operation was performed, together with the terminal ID.

When the processor 21 of the virtual POS server 20 is notified that the closing operation was performed (ACT 8, Yes), the processor 21 shifts to the settlement process (ACT 9). When the data indicating the settlement method is stored in the area Ad of the transaction information file TFL of the terminal ID received from the first communication terminal 60, the processor 21 uses the settlement method indicated by the data to settle the commodity registered in the area Ab of the transaction information file TFL (ACT 9) and complete the settlement (ACT 10, Yes).

On the other hand, when the settlement cannot be completed because the data indicating the settlement method is not stored in the area Ad of the transaction information file TFL (ACT 10, No), the processor 21 requests the first communication terminal 60 to specify a settlement method.

The processor 61 of the first communication terminal 60 displays the settlement method selection screen on the touch panel 65 in response to the request from the virtual POS server 20 and allows the consumer to specify the settlement method. The processor 61 notifies the virtual POS server 20 that the settlement method is specified by the operation of the consumer.

When the processor 21 of the virtual POS server 20 is notified of the specification of the settlement method (ACT 11, Yes), the processor 21 executes the settlement method receiving process (ACT 12). That is, the processor 21 stores data indicating the specified settlement method in the area Ad of the transaction information file TFL in which the terminal ID received from the first communication terminal 60 is set.

The processor 21 uses the settlement method indicated by the data stored in the area Ad to settle the commodity registered in the area Ab of the transaction information file TFL (ACT 9) and complete the settlement (ACT 10, Yes).

When the settlement is completed, the processor 21 determines the format of the receipt to be output for the transaction for which the settlement was completed (ACT 13). When the first communication terminal 60 is used, basically, the printer 67 provided in the first communication terminal 60 is assumed to dispense a paper receipt. When the electronic receipt membership code is set in the area Ac of the transaction information file TFL, that is, when it is specified in advance to use the electronic receipt service, the receipt format is determined to be an electronic receipt. If an electronic receipt is specified, the paper receipt may not be dispensed, or both the paper receipt and the electronic receipt may be dispensed.

The processor 21 generates receipt data (output data) based on the registration data recorded in the area Ab of the transaction information file TFL according to the determined receipt format (ACT 14) and outputs the receipt data (ACT 15). That is, when dispensing a paper receipt, the processor 21 transmits the receipt data to the first communication terminal 60. When dispensing an electronic receipt, the processor 21 transmits the receipt data together with the electronic receipt membership code to the electronic receipt server 8 via the network 4.

When the processor 61 of the first communication terminal 60 receives the receipt data from the virtual POS server 20, the processor 61 executes printing on the printer 67 based on the receipt data and dispenses a paper receipt.

When the electronic receipt server 8 receives the receipt data together with the electronic receipt membership code from the virtual POS server 20, the electronic receipt server 8 stores the receipt data in association with the electronic receipt membership code. The electronic receipt server 8 dispenses receipt data corresponding to the electronic receipt membership code when a request for viewing the receipt is received together with the electronic receipt membership code through an electronic device such as a smartphone owned by the consumer.

Next, the case where the second settlement method is executed will be described.

Before registering the commodity, it is assumed that the settlement method is specified by the operation of the consumer, and the electronic settlement including the credit card settlement is specified (ACT 5, Yes). Here, the second settlement method is executed. Data indicating the settlement method is stored in the area Ad of the transaction information file TFL. Here, it is assumed that, for example, payment by a credit card (or debit card) is specified as the method of electronic settlement. The debit card settlement method is a method in which the specified account is immediately debited when the settlement is processed.

When using a credit card, the credit card CA is mounted on the reader 68 by the operation of the consumer, as shown in FIG. 3. It is assumed that the first communication terminal 60 is used for shopping while the credit card CA is held by the reader 68. By keeping the credit card CA held by the reader 68, it is possible to read the data (card number) recorded in the credit card CA at any timing without requiring the operation of the consumer.

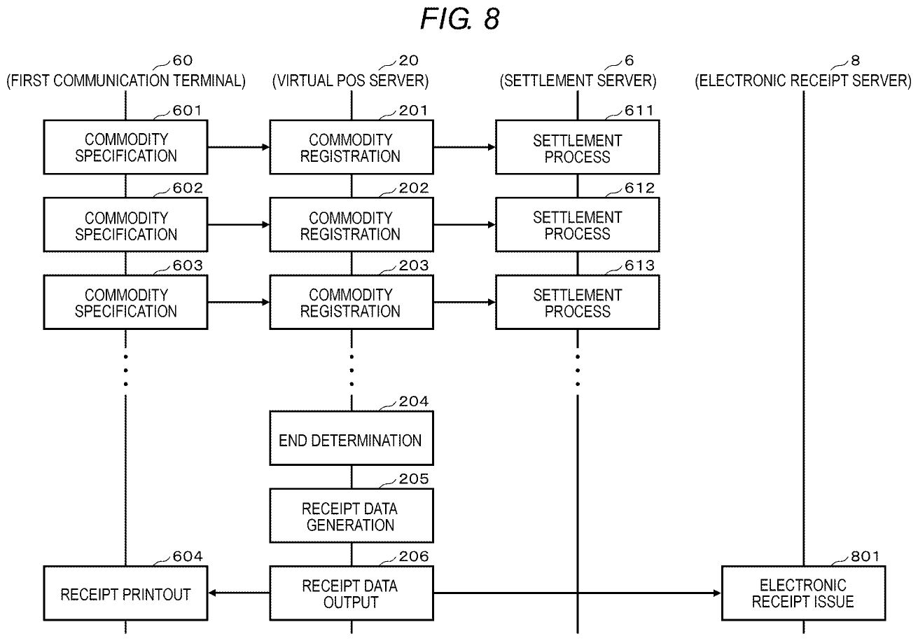

FIG. 8 is a diagram showing an outline of a processing flow when the second settlement method is executed.

The consumer causes the scanner 66 to read the barcode indicating the commodity code attached to the commodity to be purchased. When the commodity code is acquired, the processor 61 transmits the acquired commodity code to the virtual POS server 20 together with the terminal ID. Upon receiving the commodity code received from the first communication terminal 60 (ACT 20, Yes), the processor 21 of the virtual POS server 20 inquires about the data related to the commodity corresponding to the commodity code.

In response to the inquiry from the virtual POS server 20, the store server 10 reads the data corresponding to the commodity code from the commodity database and transmits the read data to the virtual POS server 20.

The processor 21 of the virtual POS server 20 temporarily stores data related to the commodity received from the store server 10 and executes a process for making a settlement for the commodity with this data.

That is, the processor 21 requests the first communication terminal 60 to input data necessary for executing settlement by the settlement method specified in advance. Here, since payment by a credit card (debit card) is specified, data (card number) from the credit card used for settlement is required to be input.

The processor 61 of the first communication terminal 60 reads the card number from the pre-mounted credit card CA through the reader 68 in response to the request from the virtual POS server 20. The processor 61 transmits the card number read from the credit card CA to the virtual POS server 20.

Upon receiving the card number input in the virtual POS server 20 (ACT 21, Yes), the processor 21 of the virtual POS server 20 requests settlement by accessing the settlement server 6 and specifying the settlement amount for one commodity corresponding to the commodity code received from the first communication terminal 60 and the card number (ACT 22).

The settlement server 6 executes the settlement process in response to the settlement request from the virtual POS server 20. The settlement server 6 notifies the virtual POS server 20 of the result of the settlement process.

When the processor 21 of the virtual POS server 20 is notified of the result of the settlement process from the settlement server 6 (ACT 23, Yes), the processor 21 determines whether the settlement was completed based on the notification. When the settlement was completed (ACT 24, Yes), the processor 21 stores the data related to the commodity received from the store server 10 in the area Ab of the transaction information file TFL in which the terminal ID received from the first communication terminal 60 is set. That is, the processor 21 registers the data of the commodity for which settlement was completed (ACT 25).

When the settlement was completed, the processor 21 notifies the first communication terminal 60 of the details (commodity name, price, or the like) of the transaction for which settlement was completed. The first communication terminal 60 causes the touch panel 65 to display information related to the commodity for which settlement was completed in response to the notification of settlement completion.

Unless the monitoring device 80 notifies the end of the use of the first communication terminal 60 (ACT 26, No), when the barcode of the commodity to be purchased is read by the first communication terminal 60 with the operation of the consumer, in the same manner as described above, the processor 21 of the virtual POS server 20 executes the settlement process for the commodity (ACT 20 to ACT 25).

As shown in FIG. 8, in the second settlement method, when the barcode of the commodity to be purchased is scanned by the first communication terminal 60 (601), the settlement process (611) for this commodity is executed, and information on the commodity for which settlement was completed is registered in the virtual POS server 20 (201).

Similarly, when the barcodes of other commodities are sequentially scanned (602, 603), the settlement process (612, 613) for each commodity is individually executed, and the information of the commodities for which settlement was completed is registered in the virtual POS server 20 (202, 203). Therefore, each time the barcode of the commodity is scanned by the first communication terminal 60, the settlement process of the commodity is executed individually, and the data of the commodity for which the settlement process was completed is sequentially registered.

If the settlement process cannot be completed on the settlement server 6, the processor 21 determines that the settlement was not completed based on the notification from the settlement server 6. For example, if the specified account used for the debit card settlement process has insufficient balance, the settlement cannot be completed. When the settlement is not completed (ACT 24, No), the processor 21 does not register the data related to the commodity to be settled in the transaction information file TFL. When the settlement is not completed, the processor 21 notifies the first communication terminal 60 of the details (commodity name, price, or the like) of the transaction for which settlement is not completed. The first communication terminal 60 causes the touch panel 65 to display information related to the commodities for which settlement was not completed in response to the notification that settlement was not completed.

Therefore, in the second settlement process, by executing the settlement process for each commodity, the settlement can be completed for the commodities that can be settled among the plurality of commodities to be purchased and the settlement can be stopped for the commodities that cannot be settled. As a result, it is possible to purchase commodities that can be settled.

In the first settlement method, since the settlement process is executed after registering a plurality of commodities, if the settlement cannot be made for the total amount of the plurality of commodities (such as insufficient balance), the purchase of all registered commodities is stopped, the registered commodity is deleted, or the settlement process is re-executed by another payment method, which causes extra effort. On the other hand, in the second settlement method, it is sufficient to end the shopping at the timing when the settlement cannot be made, and thus no extra effort is required.

When the consumer completes shopping using the first communication terminal 60, the consumer returns the shopping cart to, for example, the shopping cart storage area. The monitoring device 80 detects that the shopping cart (first communication terminal 60) was returned to the shopping cart storage area and notifies the virtual POS server 20.

The processor 21 of the virtual POS server 20 determines the end of the use of the first communication terminal 60 according to the notification from the monitoring device 80 (ACT 26, Yes) (FIG. 8, 204). The virtual POS server 20 ends the process for shopping using the first communication terminal 60 whose end was determined. That is, in the second settlement method, since the settlement process of the commodities is completed individually by simply scanning the barcode of the commodity, the closing operation for instructing the completion of the commodity registration and the execution of the settlement process is not necessary. Therefore, the operability is improved.

The processor 21 determines the format of the receipt to be output for shopping using the first communication terminal 60 whose end was determined (ACT 13). When the first communication terminal 60 was used, basically, the printer 67 provided in the first communication terminal 60 is assumed to dispense a paper receipt. When the electronic receipt membership code is set in the area Ac of the transaction information file TFL, that is, when it is specified in advance to use the electronic receipt service, the receipt format is determined to be an electronic receipt. If an electronic receipt is specified, the paper receipt may not be dispensed or both the paper receipt and the electronic receipt may be dispensed.

The processor 21 generates receipt data (output data) based on the registration data recorded in the area Ab of the transaction information file TFL, which was settled for each commodity, according to the determined receipt format (ACT 14) (FIG. 8, 205) and outputs receipt data (ACT 15) (FIG. 8, 206). That is, when dispensing a paper receipt, the processor 21 transmits the receipt data to the first communication terminal 60. When dispensing an electronic receipt, the processor 21 transmits the receipt data together with the electronic receipt membership code to the electronic receipt server 8 via the network 4.

When the processor 61 of the first communication terminal 60 receives the receipt data from the virtual POS server 20, the printer 67 executes printing based on the receipt data and dispenses the paper receipt (FIG. 8, 604).

Upon receiving the receipt data together with the electronic receipt membership code from the virtual POS server 20, the electronic receipt server 8 stores the receipt data in association with the electronic receipt membership code. The electronic receipt server 8 dispenses receipt data corresponding to the electronic receipt membership code when a request for viewing the receipt is received together with the electronic receipt membership code through an electronic device such as a smartphone owned by the consumer (FIG. 8, 801).

In the above description, the case where the consumer performs shopping using the first communication terminal 60 is taken as an example, but the same process is also executed when the second communication terminal 70 is used. However, since the second communication terminal 70 cannot dispense a paper receipt, the consumer is required to enter the electronic receipt membership code before the end of shopping so that the electronic receipt can be dispensed.

Since the second communication terminal 70 is an electronic device owned by a consumer such as a smartphone, the determination of the end of shopping using the second communication terminal 70 is executed by detecting another state different from that of the first communication terminal 60.

For example, when a predetermined certain time or more passed since the communication with the second communication terminal 70 via the access point 50 was cut off, or when the position detected by the position detection function of the second communication terminal 70 is determined to be moved to a specific range such as outside the sales floor or outside the store, the monitoring device 80 determines that the use for shopping by the second communication terminal 70 ended. The virtual POS server 20 generates and outputs the output data summarizing data for individually settled commodities in response to the determination of the end of the use of the second communication terminal 70 by the monitoring device 80.

In the second settlement process, the settlement process is completed by scanning the barcode of the commodity. Therefore, if the reading of the barcode of the commodity desired to purchase is completed, the consumer is allowed to leave the sales floor without doing any operation and without going to a predetermined place (a specific range, the place where the checkout machine 30 is installed, or the like). Therefore, there is no operation or waiting time for the settlement process for the second communication terminal 70 by the consumer, and the operability is greatly improved.

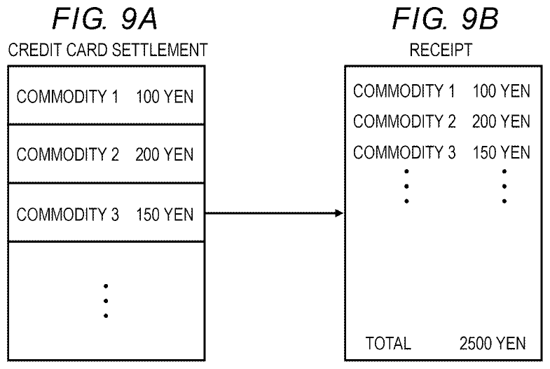

FIGS. 9A and 9B are diagrams for illustrating the output result when the second settlement method is executed.

In the second settlement method, as shown in FIG. 9A, when a plurality of commodities 1, 2, 3 . . . are purchased, the settlement process is executed for each of the commodities 1, 2, 3 . . . . Generally, when the settlement process is performed for each of the commodities 1, 2, 3 . . . , the individual sale of the commodities 1, 2, 3 . . . is one transaction. Therefore, when a paper receipt (or an electronic receipt) is output, a plurality of paper receipts corresponding to each of the commodities 1, 2, 3 . . . are output.

On the other hand, in the commodity sales processing system of the present embodiment, when a plurality of commodities 1, 2, 3 . . . are registered and purchased using the first communication terminal 60, as shown in FIG. 9B, the data of a plurality of commodities 1, 2, 3 . . . are collectively output on one paper receipt (or electronic receipt).

When compiling data for a plurality of commodities 1, 2, 3 . . . , in addition to adding the total amount as shown in FIG. 9B, it is also possible to add the total amount of consumption tax and the service-related information such as coupon grants associated with the purchase of a plurality of commodities.

Therefore, even if settlements are processed individually for a plurality of commodities 1, 2, 3 . . . , the management of shopping using receipts by the consumer is not complicated.

In the above description, when the second settlement is made, the electronic receipt server 8 is used to dispense the electronic receipt, but instead of the electronic receipt, the output data summarizing the details of the electronic settlement for a plurality of commodities may be output. The output data is stored in the commodity sales processing system 2 or an external device in association with the terminal ID, the terminal ID is specified by the smartphone or the like used as the second communication terminal 70 to read the output data via the network 4.

In the configuration of the commodity sales processing system 2 described above, the virtual POS server 20, the terminal controller 40, and the monitoring device 80 have independent configurations, but it is also possible to realize a device in which a part of the configuration is combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The processing described in the above-described embodiment can be provided to various devices by writing to a recording medium such as a magnetic disk (flexible disk, hard disk, and the like), an optical disk (CD-ROM, DVD, and the like), a semiconductor memory, and the like, as a program that can be executed by a computer. It is also possible to be transmitted through a communication medium to be provided to various devices. The computer reads the program recorded on the recording medium or receives the program via the communication medium, and the operation is controlled by the program to execute the above-described processing.

What is claimed is:

1. A commodity sales processing system comprising:
a communication interface configured to communicate with a communication terminal, the communication terminal configured to acquire commodity data regarding commodities to be purchased by a consumer during a shopping event;
a processor configured to:
set a settlement method for the shopping event that is used in settlement with the consumer for purchasing the commodities, the settlement method including a first settlement method and a second settlement method;
receive the commodity data from the communication terminal; and
execute a settlement process based on the commodity data and the settlement method, which includes:
executing the settlement process when the shopping event is completed in response to the first settlement method being set; and
executing the settlement process each time the commodity data is received from the communication terminal such that each commodity is individually settled in response to the second settlement method being set.

2. The commodity sales processing system of claim 1, wherein the processor is configured to set the first settlement method in response to receiving the commodity data from the communication terminal without first receiving an indication of a settlement selection from the communication terminal.

3. The commodity sales processing system of claim 1, wherein the processor is configured to set the first settlement method in response to receiving an indication of a cash settlement selection from the communication terminal.

4. The commodity sales processing system of claim 1, wherein the processor is configured to set the second settlement method in response to receiving an indication of a credit, debit, or electronic settlement selection from the communication terminal.

5. The commodity sales processing system of claim 1, wherein the processor is configured to:
determine that the shopping event is completed; and
generate an electronic receipt for viewing by the consumer through an electronic device of the consumer.

6. The commodity sales processing system of claim 5, further comprising the mobile terminal, wherein the mobile terminal includes a scanner configured to acquire the commodity data.

7. The commodity sales processing system of claim 6, wherein the scanner is mounted onto a cart.

8. The commodity sales processing system of claim 7, wherein the processor is configured to determine that the shopping event is completed in response to the cart being returned to a cart storage area.

9. The commodity sales processing system of claim 5, wherein the mobile terminal is a personal device of the consumer, and wherein the personal device includes a sensor configured to acquire the commodity data.

10. The commodity sales processing system of claim 9, wherein the processing circuit is configured to determine that the shopping event is completed in response to the communication interface losing connection to the personal device.

11. The commodity sales processing system of claim 9, wherein the processing circuit is configured to determine that the shopping event is completed in response to the communication interface losing connection to the personal device for more than a threshold period of time.

12. The commodity sales processing system of claim 1, wherein the processor is configured to:
store the commodity data of the commodities for which the settlement process was performed;
determine the end of the shopping event; and
output receipt data summarizing the commodity data stored in response to determining the end of the shopping event.

13. The commodity sales processing system of claim 12, wherein the processor is configured to determine an output format of the receipt data and generate the receipt data according to the output format.

14. A commodity sales process method, the method comprising:
establishing, by a server, communication with a communication terminal, the communication terminal configured to acquire commodity data regarding commodities to be purchased by a consumer during a shopping event;
receiving, by the server, the commodity data from the communication terminal;
and executing, by the server, a settlement process based on the commodity data each time the commodity data is received from the communication terminal such that each commodity is individually settled.

15. The method of claim 14, further comprising:
setting, by the server, a settlement method, the settlement method including a first settlement method and a second settlement method; and
executing, by the server, the settlement process based on the commodity data and the settlement method.

16. The method of claim 15, further comprising:
executing, by the server, the settlement process when the shopping event is completed in response to the first settlement method being set; and
executing, by the server, the settlement process each time the commodity data is received from the communication terminal in response to the second settlement method being set.

17. The method of claim 14, further comprising setting, by the server, the first settlement method in response to receiving the commodity data from the communication terminal without first receiving an indication of a settlement selection from the communication terminal.

18. The method of claim 14, further comprising setting, by the server, the first settlement method in response to receiving an indication of a cash settlement selection from the communication terminal.

19. The method of claim 14, further comprising setting, by the server, the second settlement method in response to receiving an indication of a credit, debit, or electronic settlement selection from the communication terminal.

20. The method of claim 14, further comprising:
determining, by the server, that the shopping event is completed; and
generating, by the server, an electronic receipt for viewing by the consumer through an electronic device of the consumer.
